(19) United States
(12) Patent Application Publication
(10) Pub. No.: US 2005/0078643 A1
(43) Pub. Date: Apr. 14, 2005

(54) PVLAN

(76) Inventor: Donald Paul Archiable, Chagrin Falls, OH (US)

Correspondence Address: BENESCH, FRIEDLANDER, COPLAN & ARONOFF LLP;ATTN: IP DEPARTMENT DOCKET CLERK, 2300 BP TOWER, 200 PUBLIC SQUARE, CLEVELAND, OH, 44114, US

(21) Appl. No.: 10/685,074

(22) Filed: Oct. 14, 2003

(51) Int. Cl. H04Q 7/24

(52) U.S. Cl. 370/338

(57) ABSTRACT

Systems, methodologies and other embodiments associated with creating a limited effective transmission zone in a personal very limited area network (PVLAN) are described. One exemplary system includes a driven element for transmitting a wireless signal in a limited effective zone and a shield for molding the effective zone.

### BACKGROUND

Electromagnetic radiation (EMR) threatens to saturate our home and work spaces. Electromagnetic waves may transmit television signals, radio signals, microwave communications, aviation/nautical/weather radar, cellular telephone signals, satellite telephone signals, wireless computer communications, and so on that reach into seemingly every corner of our environment. While there may be benefits associated with this radiation (e.g., more accurate weather prediction, simplified wireless communication, increased connectivity), there may also be burdens, risks, and unanticipated consequences.

For example, electromagnetic waves intended for one device may interfere with another device. Similarly, electromagnetic waves intended for one device may be intercepted by another device. Additionally, an electromagnetic wave may pass through a human who intersects the wave path as the wave travels from place to place. In the workplace, for example, a worker may have multiple signals passing through their body, possibly in dangerous power and frequency combinations. By way of illustration, on a trading floor or exchange, waves associated with cellular telephones, wireless computer communications, local video feeds and so on may all pass through a trader.

Furthermore, with the seemingly endless current desire to extend the reach of wireless systems (e.g., computer networks), the power provided to these systems may be increased. Yet the increase in power may yield diminishing returns because of the well known inverse quadratic relationship between signal strength and the distance from the signal producing apparatus (e.g., antenna) once outside the near-field region of the antenna. Thus, dramatic increases in power may produce heightened thermal exposure and/or other risks without proportional increases in system performance. In some cases, at home and at work, due to overlapping and overpowered electromagnetic fields, power density exposure limits (measured in watts per square meter (W/m²)) may rise to unhealthy levels for humans, their pets, their work equipment (e.g., computer, telephone) and other things exposed to this high volume of electromagnetic radiation.

### BRIEF DESCRIPTION OF THE DRAWINGS

The accompanying drawings, which are incorporated in and constitute a part of the specification, illustrate various example systems, methods, and so on that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 illustrates an example personal very local area network (PVLAN) system.

FIG. 2 illustrates an example office cubicle configured with a PVLAN.

FIG. 3 is a flowchart illustrating an example method associated with a PVLAN.

FIG. 4 illustrates an example transmission zone being molded into a desired shape.

FIG. 5 illustrates another example PVLAN.

FIG. 6 illustrates another example office cubicle configured with a PVLAN.

FIG. 7 illustrates a section of an example PVLAN-space element.

### DETAILED DESCRIPTION

The following includes definitions of selected terms employed herein. The definitions include various examples and/or forms of components that fall within the scope of a term and that may be used for implementation. The examples are not intended to be limiting. Both singular and plural forms of terms may be within the definitions.

“Logic”, as used herein, includes but is not limited to, hardware, firmware, software and/or combinations of each to perform a function(s) or an action(s), and/or to cause a function or action from another component. For example, based on a desired application or needs, logic may include a software controlled microprocessor, discrete logic like an application specific integrated circuit (ASIC), a programmed logic device, a memory device containing instructions, or the like. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

An “operable connection”, or a connection by which entities are “operably connected”, is one in which signals, physical communication flow, and/or logical communication flow may be sent and/or received. Typically, an operable connection includes a physical interface, an electrical interface, and/or a data interface, but it is to be noted that an operable connection may include differing combinations of these or other connection types sufficient to allow operable control.

“Signal”, as used herein, includes but is not limited to one or more electrical or optical signals, analog or digital, one or more computer or processor instructions, messages, a bit or bit stream, or other means that can be received, transmitted and/or detected. For example, a signal may be received, transmitted, and/or detected via signal paths like copper wire, fiber optic cable, radio frequencies, T1 lines, DSL lines, OC-3 lines, coaxial cable, CAT5e cable, and the like.

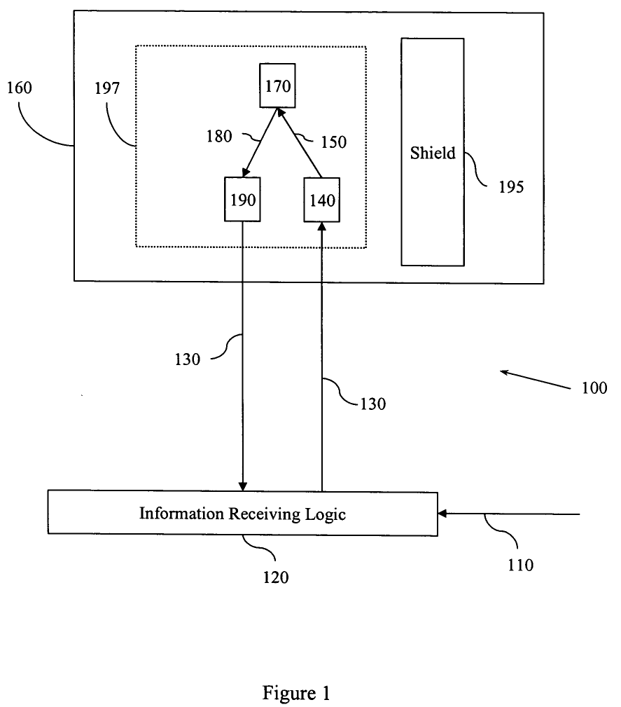

FIG. 1 illustrates a PVLAN system 100. In one example, the system 100 facilitates limiting exposure to unwanted electromagnetic radiation. System 100 may include an information receiving logic 120 configured to receive an information signal 110. The information signal 110 may include, for example, a telephone signal, a computer signal, a facsimile signal, an Internet signal, a broadcast signal, a digital subscriber line (DSL) signal, a Global Positioning System (GPS) signal, a television signal, a radio signal, and so on.

The information signal 110 may include a telephone signal that may be, for example, an analog telephone signal, a digital telephone signal, a fiber-optic telephone signal, a cellular telephone signal, and the like. The television signal may be, for example, an over the air television signal, a cable television signal, a digital television signal like a high definition television (HDTV) signal, a standard definition television signal (SDTV), an advanced compatible television (ACTV) signal, a satellite television signal, an in-house RF signal like a master antenna television (MATV) signal and/or cable antenna television (CATV) signal, and so on. The computer signal may be, for example, an IEEE 802.3 signal, an IEEE 802.5 signal, an IEEE 802.11, an IEEE 802.15.1 signal and the like. The radio signal may be, for example, an AM signal, an FM signal, an XM signal, a shortwave signal, and so on.

Thus, in the information signal 110 the information receiving logic 120 may receive a variety of signals from a variety of sources in a variety of formats. In one example, the information receiving logic 120 may be configured to process signals that are typically transmitted in the L band range (e.g., 500 Mhz to 1.5 GHz). While L band is described in some examples, it is to be appreciated that other ranges may be employed. To facilitate reducing exposure to unwanted electromagnetic radiation, these signals may be received by system 100 by wired rather than wireless methods and then distributed in limited transmission zones.

The information receiving logic 120 may receive the information signal 110 via, for example, fiber optic cable, coaxial cable (e.g., RG59U 75 Ohm, RG58U 50 ohm, RG8), unshielded twisted pair (UTP), shielded twisted pair (e.g., Cat 5, Cat 5e, Cat 6e, Cat 7) and so on. Additionally, it is to be appreciated that the information receiving logic 120 may be configured as various devices. For example, the information receiving logic 120 may be configured as a terminal, a router, a bus, a bridge, a computer, and so on.

The information receiving logic 120 may be configured to identify various signals in the information signal 110 and to selectively transfer the signals and/or an intermediate signal derived from the signal to a driven element 140, via, for example, a transmission line 130. It is to be appreciated that electronic components like an amplifier (not illustrated) may be involved in transferring the intermediate signal from the information receiving logic 120 to the driven element 140. Identifying and/or deriving an intermediate signal from the information signal 110 may include, for example, demodulating a signal, demultiplexing a signal, phase shifting a signal, frequency shifting a signal and so on. By way of illustration, the information signal 110 may include time division multiplex access (TDMA) signals, code division multiple access (CDMA) signals and so on. Thus, the information receiving logic 120 may be configured to separate and/or derive signals from the information signal 110 and provide the separated and/or derived signals to a driven element 140.

The driven element 140 may be, for example, an omni directional antenna, a yagi antenna, a horn antenna, a spiral antenna, a helical antenna, a loop antenna, a blade antenna, a sector antenna, and the like. Thus, the driven element 140 is understood to be a device that may transmit signals via electromagnetic radiation. By way of illustration, a first information signal, like the email packet, may be sent to a first driven element 140 that transmits email via, for example, an IEEE 802.11 transmission, while a second information signal like the telephone packet, may be sent to a second driven element 140 that transmits cellular telephone communications. While the driven element 140 is described transmitting signals, it is to be appreciated that in one example the driven element 140 and/or an apparatus associated with the driven element 140 may, substantially simultaneously, receive transmissions. Thus, the PVLAN system 100 may, in one example, perform simplex and/or duplex communications. Since the driven element 140 can be configured to broadcast electromagnetic waves at various powers and various frequencies it will be appreciated by one skilled the art that the driven element 140 may be constructed from various materials (e.g., copper wire) of various sizes (e.g., one quarter inch to twelve inches) and various shapes. In one example, the driven element 140 may be, for example, a length of moldable and/or formable copper wire like a length of #12, #14 or #16 AWG wire. Additionally, it is to be appreciated that the driven element 140 may be configured for directional transmissions.

The driven element 140 may be connected to the information receiving logic 120 and/or an amplifier (not illustrated) by, for example, transmission lines 130. The transmission lines 130 may include, for example, a fiber-optic cable (e.g., multi-mode fiber), a coaxial cable, a low loss cable, a small computer system interface (SCSI) cable, a serial digital interface (SDI) cable, a serial data digital interface (SDDI) wire, a local area network (LAN) cable, an elliptical wavelength guide cable, a rectangular wavelength guide cable, a ribbon cable, an unshielded twisted pair cable, a shielded twisted pair cable, and so on. Thus, a first intermediate signal (e.g. the email packet) may be sent from the information receiving logic 120 to a first driven element 140 via a first transmission line 130 (e.g. a LAN cable), while a second intermediate signal (e.g. the telephone packet) may be sent from the information receiving logic 120 to a second driven element 140 via a second transmission line 130 (e.g. a coaxial cable).

The driven element 140 may be configured to transmit an outbound signal 150 at a power P and a frequency F. Power P may be, for example, in a range from 0.01 mW to 1 mW. Frequency F may be, for example, in a range from 500 MHz to 1.5 GHz. P and/or F may determine attributes like the size, shape, and so on of a transmission zone 160. In a PVLAN system 100, the outbound signal 150 will have a limited range, extending, for example, merely to the edge of a thirty six inch transmission zone 160. This facilitates creating a localized functional area for information transmission while limiting user and/or electronic equipment exposure to unwanted electromagnetic energy. This localized functional area may be, for example, less than thirty six inches in a plane. While P is described being in the range from 0.01 mW to 1 mW and while F is described being in the range 500 MHz to 1.5 GHz, it is to be appreciated that other wider and/or more narrow power and/or frequency ranges may be employed.

The outbound signal 150 may be received by an electronic device 170 positioned in the transmission zone 160. The electronic device 170 may be, for example, a computer, a personal digital assistant (PDA), a facsimile machine, a global positioning system (GPS), a telephone, a radio and the like. Thus, the outbound signal 150 may be delivered in a variety of formats in a variety of combinations of powers and frequencies. By way of illustration, the outbound signal 150 may be a wireless computer communication signal like an IEEE 802.11 signal in the 900 MHz and/or 5.4 GHz range. Similarly, the outbound signal 150 may be, for example, a cellular telephone signal in the 800-900 MHz range at a power of 0.01 mW to 0.1 mW. Likewise, the outbound signal 150 may be, for example, a data signal in the 2.4 GHz range, a video signal in the 900 MHz range, a Blackberry signal in the 900 MHz range at a power of 0.5 mW and the like. Thus a PVLAN system 100 may generate one or more limited transmission zones 160 that facilitate close range communications with a variety of electronic devices 170.

Compare a PVLAN with an outbound cellular signal that is transmitted in the 860 MHz range at a power of 0.01 mW to a typical outbound cellular signal in the 860 MHz range transmitted at a power of 4.8 mW. The comparison illustrates reductions in electromagnetic radiation exposure associated with an example PVLAN. Similarly, the comparison exposes reducing the likelihood that a signal can be intercepted since the transmission zone 160 is so limited. Additionally, the comparison exposes reducing the likelihood that an outbound signal 150 will interfere with another transmission.

The electronic device 170 may transmit an inbound signal 180 that is received by a receiver 190. The inbound signal 180 may be, for example, an AM radio signal in the 540-1630 KHz range, an FM radio signal in the 88-174 MHz range, a television signal in the 54-806 MHz range, and so on. The receiver 190 may be, for example, an antenna like a super heterodyne receiver, a co-axial receiver, and the like. Since the receiver 190 may receive the inbound signal 180 from a variety of devices in a variety of formats on a variety of frequencies with a variety of power ranges, the receiver 190 may be configured in various shapes and constructed from various materials. The receiver 190 may be configured to transfer an intermediate signal derived from the inbound signal 180 back to the information receiving logic 120 via the transmission lines 130.

The system 100 may include a shield 195 configured to affect electromagnetic radiation in and/or approaching the transmission zone 160. Affecting the electromagnetic radiation can include, for example, blocking, reflecting, refracting, and/or filtering electromagnetic radiation. For example, the shield 195 may be placed within the transmission zone 160 to reduce its size. The shield 195 may additionally and/or alternatively be placed outside the transmission zone 160 to facilitate mitigating interference from unwanted electromagnetic radiation signals and/or to facilitate mitigating interfering with other systems. In one example, the system 100 may include two or more shields 195 that are positioned, for example, one inside and one outside the transmission zone 160. This positioning may limit the size of transmission zone 160, mitigate interference from unwanted electromagnetic radiation signals, and/or mitigate interfering with other systems. Thus, the shield 195 can be configured to mold the transmission zone 160 into a localized functional area 197, which may be referred to as an effective transmission zone 197.

A shield 195 may be, for example, a faraday cage, a copper mesh screen, a welded sheet aluminum plate, a metal textile shield, a conductive plastic film, a wire mesh, a brass plate, a tin plated steel plate, a nickel silver plate, a conductive fabric, a conductive paint and so on. In one example, the shield 195 may be a screen mesh that is a layer in a plastic laminate. In one example the shield 195 may be configured to block spectrum from 0 KHz to 1.5 GHz at a maximum RF penetration of about 1 W minimum. In another example, the shield 195 may be configured to be wavelength frequency specific, which can mitigate the effects of specific waves. In one example the shield 195 may be a faraday cage that is constructed from materials like brass, a brass/copper mix, solid copper, tin, platinum, and so on. While a shield 195 is illustrated in a first position, it is to be appreciated that the shield 195 may be positioned as, for example, a back shield, an under shield, and so on. In another example, a shield(s) configured to define a linear area as a portion of a faraday cage may be bonded with other such shield(s). These shields may be, for example, concealed within a cubicle wall, a desktop, a chair back, an airline flip-out table, and so on. In one example, the shield(s) may be bonded to a ground. The ground may be, for example, connected to a mechanical ground (e.g., three phase, four wire) and/or to a digital ground (e.g., three phase, five wire, 0.01 ohm to ground). The ground may be attached, for example, to a ground counterpoise.

To illustrate how the system 100 may function in one example, consider that the information receiving logic 120 may receive an information signal 110 containing an email message. An intermediate signal derived from the information signal 110 may be routed by the information receiving logic 120 to a driven element 140 via a transmission line 130. The driven element 140 may transmit the email message via electromagnetic radiation in an outbound signal 150. The outbound signal 150 may be transmitted at a power P and a frequency F that determine attributes of the transmission zone 160. Shields 195, located inside and/or outside the transmission zone 160 may reduce and/or shape the transmission zone 160 to an effective transmission zone 197. This may facilitate protecting the outbound signal 150 from interference from unwanted electromagnetic radiation.

An electronic device 170, in this example a computer configured for wireless communications, is positioned with the effective transmission zone 197 and thus receives the email message carried by the outbound signal 150. If the electronic device 170 is not positioned in the effective transmission zone 197, then the electronic device 170 may not receive the outbound signal 150. In the example, a user may read the email and send a response. Thus, an outbound electromagnetic signal 180 may be transmitted from the electronic device 170 to a receiver 190. The receiver 190 may then convert the outbound signal 180 and transmit an intermediate signal derived from the outbound signal 180 back to the information receiving logic 120 via the transmission line 130. In one example, the system 100 may be unidirectional and thus may not include the receiver 190.

One or more components of the PVLAN system 100 are integrated into a PVLAN-space element. For example, the driven element 140, the receiver 190, and the shield 195 may be integrated into a desk top. By way of illustration, the driven element 140 and the receiver 190 may be embedded into a middle layer of a multi-layer desk top, and the shield 195 may be embedded in a lower layer of the desk top. Similarly, the transmission lines 130, the driven element 140, and the shield 195 may be integrated into a cubicle wall. For example, the shield 195 may be implemented as a wire mesh that is incorporated into a fabric covering for the cubicle wall. The fabric covering may hide the driven element 140 and the transmission lines 130 that are attached to an inner member of the cubicle wall. While a desk top and a cubicle wall are provided as example PVLAN-space elements, other examples are provided below.

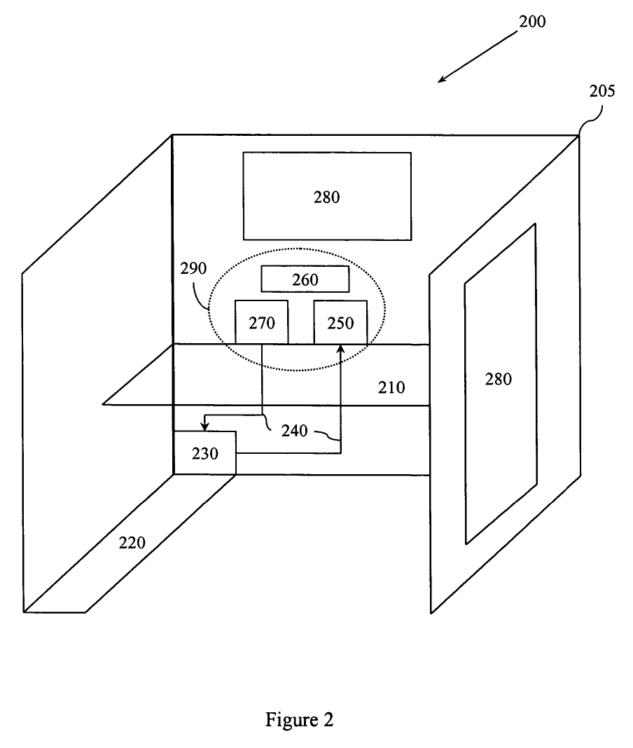

FIG. 2 illustrates a PVLAN system 200 configured for use in an office cubicle 205. While a cubicle 205 is described, it is to be appreciated that other structures and/or pieces of furniture (e.g., table, airplane seat, automobile interior, medical furniture, medical enclosure, academic table, conference room table, corporate audio/visual area, trading floor station, exchange pen) may include PVLAN-space elements into which elements of a PVLAN system can be integrated. The cubicle 205 may include, for example, a workspace 210. The workspace 210 may be, for example, a horizontal surface like a desktop or a cabinet base, a vertical surface like a wall or display area, and so on. The workspace 210 is an example of a PVLAN-space element. The system 200 may include an information receiving logic 230. The information receiving logic 230 may be, for example, a printed circuit card, a computer, and the like. In one example, the information receiving logic 230 may be, for example, integrated into the cubicle 205, attached to the cubicle 205, or located adjacent to the cubicle 205. Thus, the structure and/or piece of furniture may have one or more components of a PVLAN integrated into or integrally associated with them. Being integrated into a PVLAN-space element like a portion of a structure (e.g., wall or surface) or a portion of a piece of furniture (e.g., airplane seat) can include, for example, being embedded into the structure or furniture, being part of the structure or furniture (e.g., a fabric covering), being laminated to the structure, being attached to the structure or furniture, being a layer in the structure, and so on.

The information receiving logic 230 may be configured to receive an information signal from a wire routed through a chase 220. The chase 220 may be configured to provide a path for transmission media configured to transmit information signals to the information receiving logic 230. The information signals may be, for example, telephone signals, computer signals, and so on. The chase 220 may be, for example, run above a floor on which the structure and/or piece of furniture rests, run below the floor, and/or run within a wall of the structure and/or piece of furniture (e.g., cubicle 205). While a chase 220 is illustrated, it is to be appreciated that the information receiving logic 230 may additionally and/or alternatively receive a variety of signals by wireless means like radio frequency waves, infrared waves, and so on.

The information receiving logic 230 may be configured to identify various signals in the information signal and to selectively transfer one or more intermediate signals derived from the information signal to a driven element 250, via, for example, a transmission line 240. Deriving an intermediate signal from an information signal may include, for example, separating one signal from another signal, amplifying a signal, demultiplexing a signal, demodulating a signal, phase shifting a signal, frequency shifting a signal, and so on. The driven element 250 may be, for example, an omni directional antenna, a yagi antenna, and the like. Thus the driven element 250 is understood to be a device that may transmit signals via electromagnetic radiation. Furthermore, the driven element 250 may be, for example, integrated into the cubicle 205, attached to the cubicle 205, integrated into the workspace 210, attached to the workspace 210 and so on. In an airline example the driven element 250 may be integrated into and/or attached to a table that folds down from a seat back and/or flips up from an armchair. Thus it is to be appreciated that the driven element 250 and/or other components of a PVLAN may be located in a variety of locations.

The transmission lines 240 may be, but are not limited to being, a fiber-optic cable, a coaxial cable, and so on. Additionally, the transmission lines 240 may be, for example, integrated into the cubicle 205, attached to the cubicle 205, integrated into the workspace 210, attached to the workspace 210, and so on. By way of illustration, a first intermediate signal (e.g. the email packet) may be sent from the information receiving logic 230 to a first driven element 250 that is attached to the workspace 210 via a first line (e.g. a LAN cable) 240 integrated into the cubicle 205, while a second intermediate signal (e.g. the telephone packet) may be sent from the information receiving logic 230 to a second driven element 250 that is integrated into a wall of the cubicle 205 via a second line (e.g. a coaxial cable) 240 that is attached to the workspace 210.

The driven element 250 may be configured to transmit an outbound signal at a predetermined power P and a predetermined frequency F that may determine transmission zone attributes like size, shape, and so on. Thus the outbound signal will have a limited range, extending to the edge of the transmission zone, thereby creating a localized functional area for information transmission. The localized functional area may, therefore, cover a work surface with signals for an electronic device on the work surface but not send signals into the body of a person seated near the work surface nor into an adjacent cubicle.

The system 200 may include a shield 280 configured to mold the zone 290, to insulate the zone 290, and/or to isolate the zone 290. Shields may have various effects on electromagnetic waves. The effects may include, for example, reflecting, refracting, and/or diffracting electromagnetic waves. Thus, a shield can block undesired waves from entering a certain area by reflecting the waves away from the area. Additionally, and/or alternatively, a shield can direct desired waves into an area by, for example, bending and/or changing the wave direction. Thus, strategically placing shields can facilitate creating very localized (e.g., 1 meter or less) isolated and/or insulated effective zones for electromagnetic waves generated at low power (e.g., milliwatts) in a restricted frequency band.

The shield 280 may be positioned relative to the transmission zone to reduce its size, creating an effective transmission zone 290. The shield 280 may additionally and/or alternatively be positioned to mitigate interference from unwanted electromagnetic radiation signals. Additionally, the system 200 may be constructed using multiple shields 280 that are located, for example, both within and outside the transmission zone. This positioning may reduce the transmission zone size to an effective transmission zone 290 and mitigate interference from unwanted electromagnetic radiation signals. The shield 280 may be, for example, a faraday cage, a copper mesh screen, and so on. A shield may be built, for example, from a thin flexible metal screen, a metal mesh fabric, and so on. This type of screen may be integrated into a fabric, may be a fabric, may be integrated into a solid (e.g., plastic) and other materials, and so on. Similarly, this type of screen may be associated with (e.g., bonded to, coupled onto, linked to) fabrics, solids, screens, and so on. Thus, a shield may be integrated into (e.g., be a structural part of) and/or be associated with (e.g., attached to) items like office walls, cubicle walls, desktops, cabinet walls, carpets, doors, shelving, flip out tables, chairs, and so on. Furthermore, shield 280 may be, for example, integrated into the cubicle 205, integrated into the workspace 210, attached to the cubicle 205, attached to the workspace 210, a coating on the cubicle 205, a coating on the workspace 210, and so on.

The outbound signal may be received by an electronic device 260. The electronic device 260 may be a variety of devices like a computer, a radio and the like. The electronic device 260 may transmit an inbound signal via electromagnetic waves to a receiver 270. Thus the receiver 270 may be an antenna like a super heterodyne receiver, a co-axial receiver, and so on. Like the driven element 250, the receiver 270 may be, for example, integrated into the cubicle 205, and so on. The receiver 270 may be configured to transfer an intermediate signal derived from the inbound signal back to the information receiving logic 230 via the transmission lines 240. While a cubicle is described in FIG. 2, it is to be appreciated that other structures (e.g., conference room, classroom, operating room, vehicle) and/or apparatus (e.g., airline seat, office chair, waiting room chair, table in coffee shop) could house and/or be associated with a PVLAN and/or its components.

Thus, in one example, a table in a conference room could be configured with PVLAN system elements (e.g., driven elements, shields) that establish a number of effective zones. For example, a twenty-four inch radius zone in which IEEE 802.11 data is available could be created every fifty six inches on the table. The PVLAN zone may, for example, be configured to be less than twenty four inches in one or more planes. The table may be decoratively marked to indicate the location(s) of the zones. Thus, rather than creating a single one hundred and fifty foot radius zone in which the IEEE 802.11 transmissions are available, which zone may extend outside the conference room, a number of PVLAN zones can be created. In one example these PVLAN zones are configured to fall within the exceptions of FCC Part 15.

While FIG. 2 illustrates a receiver 270, it is to be appreciated that some PVLANs may be unidirectional and thus may not include a receiver 270. Similarly, while FIG. 2 illustrates a receiver 270 and a separate driven element 250, it is to be appreciated that the driven element 250 and the receiver 270 may be incorporated into a transceiver that permits, for example, simplex and/or duplex communications.

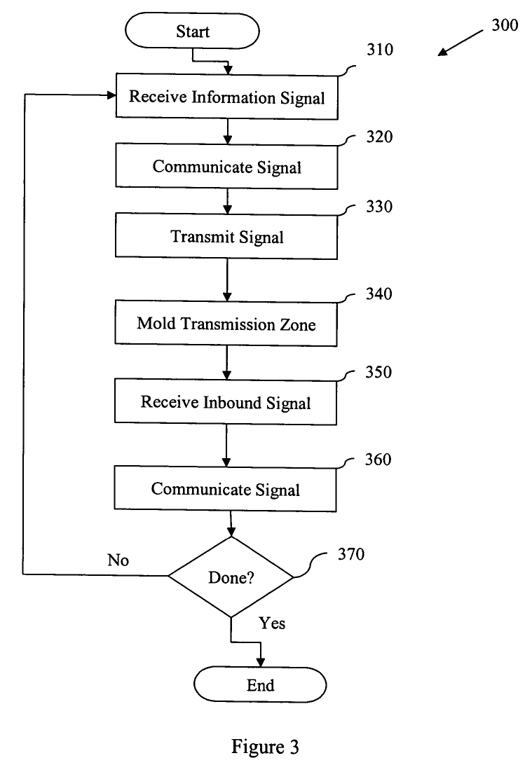

Example methods may be better appreciated with reference to the flow diagram in FIG. 3. While for the simplicity of explanation, the illustrated methodology is shown and described as a series of blocks, it is to be appreciated that the methodology is not limited by the order of the blocks, as some blocks can occur in different orders and/or concurrently with other blocks from that shown and described. Moreover, less than all the illustrated blocks may be required to implement an example methodology. Furthermore, additional and/or alternative methodologies can employ additional, not illustrated blocks.

FIG. 3 illustrates a method 300 associated with a PVLAN. The method 300 may include, at 310, receiving an information signal. The information signal may contain one or more data packets and/or non-packetized signals and may include, for example, a telephone signal, a computer signal, and the like. At 320, the information signal and/or an intermediate signal derived from the information signal may be communicated to a transmitter.

At 330, the intermediate signal and/or an outbound signal derived from the intermediate signal may be transmitted at a selective power P and a selective frequency F. The power P and/or frequency F may be established at levels that produce a transmission zone with certain desired features like size, shape, power saturation, and so on. The frequency of the outbound information signal may be, for example, in a range of 500 MHz to 1.5 GHz. The power of the outbound information signal may be, but is not limited to being, in a range of 0.01 mW to 1 mW. It is to be appreciated that other power and/or frequency ranges can be employed. The transmission zone may be limited, for example, to twenty four inches in one or more planes.

At 340, the shape and size of the transmission zone may be molded by, for example, shields. The location of one or more shields in relation to the source of the transmission combined with the power P and frequency F of the transmission may determine the final shape and size of the transmission zone. In one example, the transmission zone may be moldable in three directions.

At 350 an incoming electromagnetic radiation information signal is received by a receiver and derived into an intermediate signal. At 360 the intermediate signal may be provided to another device(s). At 370 the method 300 determines whether additional communication is required and/or desired. If so, the steps of 310 through 360 may be repeated until communication through the PVLAN concludes. It is to be appreciated that some PVLAN systems may be broadcast only and thus steps 350 and 360 may not be present in some methods. Additionally, it is to be appreciated that an example PVLAN system may transmit and receive substantially simultaneously.

It is to be appreciated that one or more of the acts illustrated in method 300 will be performed by a structure that is embedded into a PVLAN-space element.

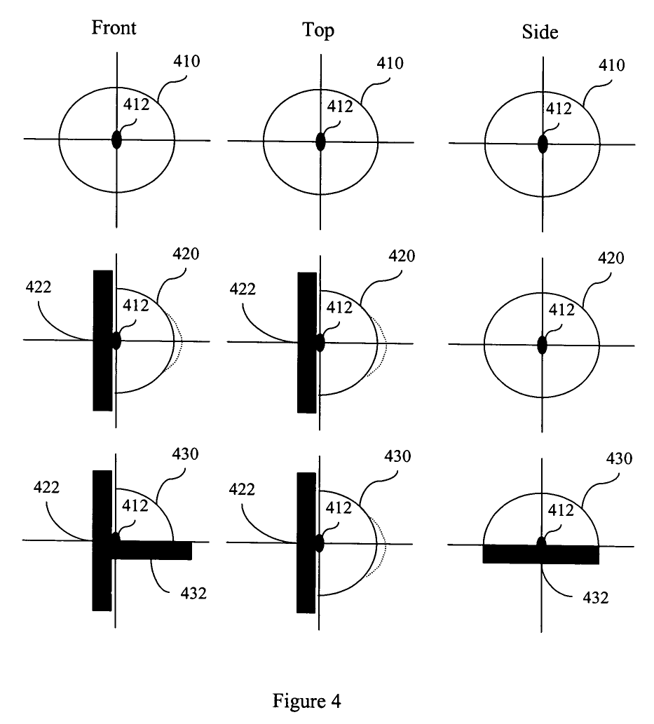

FIG. 4 illustrates front, top and side views of a limited range PVLAN transmission zone being molded into a desired shape by shields. While molding is discussed, it is to be appreciated that the shields could also be employed to limit interference into a transmission zone and to limit interference caused by a transmission zone. An initial transmission zone 410 may be created by a driven element 412 located in the center of the initial transmission zone 410. The initial transmission zone 410 may be, for example, substantially spherical although other initial shapes may be created depending, for example, on the type and/or orientation of the driven element 412. In this example, the initial transmission zone 410 has the same spherical shape when viewed from the front, top, and/or side. By using a reduced power driven element 412, the initial transmission zone 410 may be limited in size to a personal, very limited area that can be employed in, for example, a PVLAN. However, a designer may not require and/or desire a spherical shape for a transmission zone. For example, if a work space is designed for a laptop computer to sit on a work surface, then it may be beneficial to restrict the zone in which the laptop can operate to the work surface top. Similarly, if the work space is designed for the laptop computer to sit on the left side of the work surface, then it may be beneficial to restrict the transmission zone to the right side of the driven element 412 and to place the driven element 412 on the left side of the work surface. By way of illustration, an airline passenger may place a laptop computer on a flip-out table. Thus, the table can be configured as a part of a PVLAN system to create a very limited transmission zone (e.g., six inches) above the table top. It is to be appreciated that the driven element 412 and/or the shields may be integrated into a PVLAN-space element like a work surface.

An intermediate transmission zone 420 may be molded from the initial transmission zone 410. The intermediate transmission zone 420 may extend rightward from the driven element 412. The intermediate transmission zone 420 may be molded by, for example, placing a shield 422 to block substantially all transmissions from the driven element 412 that would otherwise travel to its left. The shield 422 may also protect the intermediate transmission zone 420 from unwanted waves (e.g., interference) like those from a 60 Hz, 120V circuit and/or those from a transmission zone with a similar frequency range. Thus, the intermediate transmission zone 420 may be more insulated and/or isolated than the initial transmission zone 410. If the shield 422 is designed to selectively reflect waves emitted from the driven element 412, then the intermediate transmission zone 420 may have an elongated and/or otherwise distorted shape. The shield 422 can be configured to increase, decrease and/or have substantially no effect on distorting the shape of the intermediate transmission zone 420. In one example, based on the presence and/or properties of shield 422, the driven element 412 may employ less power to create the intermediate transmission zone 420.

The intermediate transmission zone 420 may be further molded into a target transmission zone 430 located above the work space work surface by, for example, the strategic location of a shield 432. Whereas shield 422 may have “cut off” the left side of initial transmission zone 410 to mold the intermediate transmission zone 420, shield 432 may similarly “cut off” the bottom of the intermediate transmission zone 420 to produce the target transmission zone 430. Through the selective placement of shields 422 and 432 the target transmission zone 430 in which an electronic device like a laptop computer on a work surface will function can be selectively created. This facilitates, for example, reducing the amount of electromagnetic radiation that passes through the body of a user of the laptop computer. Furthermore, the shielding can reduce the amount and/or type of unwanted electromagnetic waves passing through the laptop and/or passing from the laptop outside of a desired zone. This facilitates mitigating, for example, interference, crosstalk, interception, and so on.

By way of illustration, without shield 432, the knees and thighs of a user may be inside a part of the initial transmission zone 410 that falls below the work surface. But there is no apparent need to subject the knees and thighs to electromagnetic waves intended for a computer on the work surface. Thus shield 432 may mold the initial transmission zone 410 to prevent this unwanted exposure. Similarly, without shield 422, the driven element 412 may transmit into a neighboring workspace and/or be influenced by electromagnetic fields in that neighboring workspace. Thus, shield 422 may mold the initial transmission zone 410 to mitigate these undesired effects. While a spherical zone being molded into a quarter sphere by placing two shields is illustrated, it is to be appreciated that zones with other initial shapes may be molded into other resulting shapes by placing one or more shields.

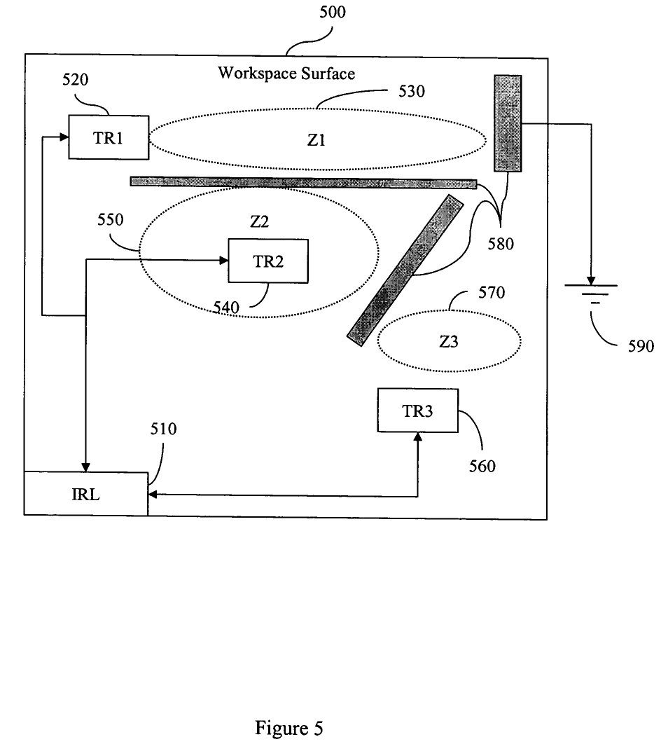

FIG. 5 illustrates a workspace surface 500 configured with three PVLAN zones. The workspace surface 500 may be operably connected to an information receiving logic 510 that may selectively distribute various information signals to various driven elements, receivers, and/or transceivers associated with the workspace surface 500. In one example, the information receiving logic 510 may be embedded in and/or attached to the workspace surface 500. The information receiving logic 510 may distribute a first signal to a driven element 520 that creates a first PVLAN zone 530, a second signal to a transceiver 540 that creates a second PVLAN zone 550, and a third signal to a transceiver 560 that creates a third PVLAN zone 570. The driven element 520 and transceivers 540 and 560 may be integrated into the workspace surface 500. For example, they may be a layer in a multilayer laminate.

The zones 530, 550, and 570 may be molded and/or isolated by a set of shields 580. Additional shields (not illustrated) may control the vertical dimensions of the zones by, for example, preventing radiation passing downward through the workspace surface 500 and/or passing upward through a cabinet bottom. Similarly, cubicle walls surrounding the workspace surface 500 may substantially isolate the workspace surface 500 from other electromagnetic waves. The shields 580 may, in one example, be electrically grounded to a reference ground point 590. The shields 580 may, for example, be embedded into the workspace surface 500, be a layer in a multi-layer laminate, and so on.

While three zones 530, 550, and 570 are illustrated as being non-intersecting fields it is to be appreciated that in some examples PVLAN zones may intersect, overlap, and so on.

The driven element 520 may, for example, create a PVLAN zone 530 in which a local television signal may be received. Thus, the workspace surface 500 may be marked with, for example, a colored oval that indicates where a television can be placed to receive the local signal. By way of illustration, the zone 530 may be a sixty centimeter wide by ninety centimeter deep zone in which two broadcast television channels can be received.

Transceiver 540 may, for example, create a PVLAN zone 550 in which personal computer information may be communicated (e.g., transmitted, received). Thus, the workspace surface 500 may be marked with, for example, a patterned area that indicates where a computer can be placed to receive and/or transmit computer information. By way of illustration, the zone 550 may be a fifty centimeter wide by seventy centimeter deep zone in which IEEE 802.11 data may be transmitted and received. By way of further illustration, the PVLAN zone 550 may be configured to transmit and/or receive signals in the 1 GHz range.

Transceiver 560 may, for example, create a PVLAN zone 570 in which cellular telephone traffic can be transmitted and/or received. Thus, the workspace surface 500 may be marked with, for example, a stylized telephone logo that indicates where a telephone can be positioned. Therefore, a system for receiving a real time news service that delivers updates via cellular telephone communication may be positioned in zone 570. By way of further illustration, the PVLAN zone 570 may be configured to transmit and/or receive signals in the 850-900 MHz range.

While three zones are illustrated, it is to be appreciated that a workspace surface(s) could be configured with a greater and/or lesser number of zones of various sizes and shapes. Furthermore, while three shields are illustrated, and other shields are described, it is to be appreciated that a greater and/or lesser number of shields may be employed. Similarly, while the workspace surface 500 is illustrated as a horizontal surface, it is to be appreciated that other surfaces (e.g., walls) may be configured to create, mold, and/or indicate the location of PVLAN zones.

Wireless networks operate by transmitting and receiving radio waves. Transmission ranges of conventional wireless networks, while providing for expanded network coverage, may also make a wireless network susceptible to security breaches. Two common wireless network protocols are IEEE 802.11b and IEEE 802.15.1 (Bluetooth). Transmitters configured to emit radio waves in accordance with the IEEE 802.11 protocol may have a transmission radius as large as one hundred and fifty feet, while transmitters configured to emit radio waves in accordance with the Bluetooth protocol may have a transmission radius as large as thirty feet.

Without additional security measures, an intruder with access to the wireless transmissions may gain unauthorized access to an 802.11b or Bluetooth system via a wireless enabled notebook computer, PDA, or the like configured with a “snooper” software program. Physical boundaries like exterior walls, interior walls, floors, and ceilings generally do not obstruct electromagnetic transmissions. Therefore, an individual equipped as described above may access a wireless network located in, for example, a casino, an embassy, a law office, a bank, a government building, and so on, without entering the building.

Unauthorized access to wireless networks has been addressed by applying encryption systems to wireless networks. However, encryption may offer only limited effectiveness. Encryption systems, by their nature, must be capable of being decrypted. “Hackers” make a habit out of defeating attempts at maintaining computer network security. Once the encryption system has been identified and decrypted, the wireless network may be once again exposed to uninvited access. This scenario can repeat itself causing the wireless network provider to reinvest in increasingly complex and costly encryption methods. Additionally, legacy computer networks may not be capable of running modern encryption systems. This may lead the wireless network provider to accept a possibly ineffective encryption system and/or to incur further additional costs to update their system. Thus, a PVLAN system may be configured with one or more limited range zones that facilitate mitigating security issues like those described above.

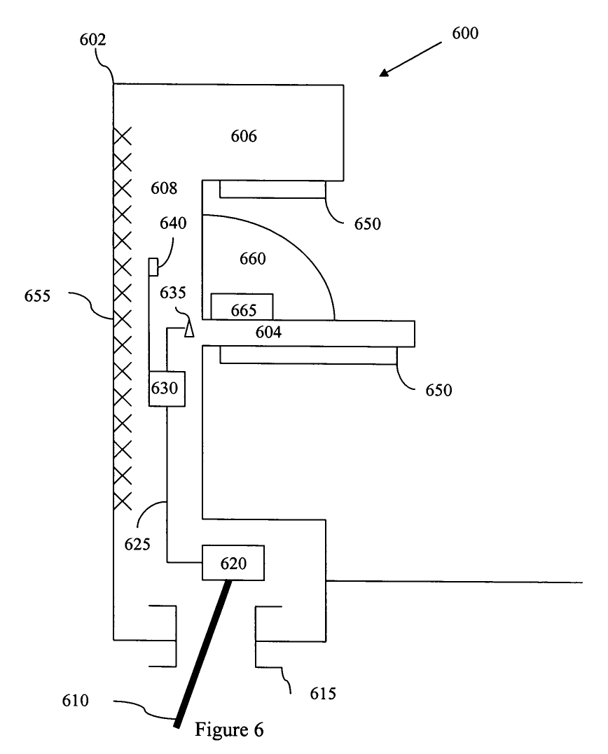

FIG. 6 illustrates another example PVLAN system 600 configured for use in an office cubicle 602. The cubicle 602 may include, for example, a workspace 604, an overhead cabinet 606, a back wall 608, and so on that may function as PVLAN-space elements into which PVLAN components can be integrated. The system 600 may include an information receiving logic 620. The information receiving logic 620 may be, for example, a computer and so on. Additionally, the information receiving logic 620 may be, for example, integrated into the cubicle 602, attached to the cubicle 602, and so on. The workspace 604, cabinet 606, and back wall 608 are examples of a PVLAN-space element.

The information receiving logic 620 may be configured to receive an information signal from one or more transmission media 610 routed through a chase 615. The chase 615 may be configured to provide a path for transmission media 610 to the information receiving logic 620. The transmission media 610 may be, for example, a fiber-optic cable, a coaxial cable, and so on. The information signals may be, for example, telephone signals, computer signals, and so on. The chase 615 may, for example, run above a floor on which the cubicle 602 sits, run below the floor on which the cubicle 602 sits, run through a structural or decorative component of cubicle 602 and so on.

The information receiving logic 620 may be configured to identify various signals in the information signal received from the transmission media 610 and to selectively transfer the signals to an amplifier 630 via, for example, a transmission line 625. The amplifier 630 may be operably connected to a driven element 635. The amplifier 630 may be, but is not limited to being, a linear power amplifier, a small signal low noise amplifier, and the like. The amplifier 630 is understood to be a device that may increase the power of electromagnetic signals. Furthermore, the amplifier 630 may be, but is not limited to being, integrated into the cubicle 602, attached to the cubicle 602, integrated into the workspace 604, or attached to the workspace 604.

The driven element 635 may be, for example, an omni directional antenna, a yagi antenna, and the like. Thus, the driven element 635 is understood to be a device that may transmit signals via electromagnetic radiation. Furthermore, the driven element 635 may be, for example, integrated into the cubicle 602, attached to the cubicle 602 and so on. The transmission lines 625 may be, for example, a fiber-optic cable, a coaxial cable, and so on. The transmission lines 625 may be, for example, integrated into the cubicle 602, attached to the cubicle 602, and so on. Thus, in one example, a first signal (e.g. the email packet) may be sent from the information receiving logic 620 to a first amplifier 630 operably connected to the first driven element 635 integrated into the back wall 608 via a transmission line (e.g. a LAN cable) 625 attached to the cubicle 602, while a second signal (e.g. the telephone packet) may be sent from the information receiving logic 620 to a second amplifier 630 operably connected to a second driven element 635 attached to the cubicle 602 via a transmission line (e.g. a coaxial cable) 625 integrated into the back wall 608.

The driven element 635 can be configured to transmit an outbound signal at a predetermined power P and a predetermined frequency F. The system 600 may include a first shield 650 configured to block electromagnetic radiation from traveling upwards through cabinet 606, for example. The system 600 may also include a second shield 655 configured to shield the zone 660 from interference from unwanted electromagnetic radiation signals.

The outbound signal may be received by an electronic device 665. The electronic device 665 may be, for example, a computer, and the like. In one example, the electronic device 665 may transmit an inbound signal to a receiver 640. The receiver 640 may be, for example, an antenna. The receiver 640 may be integrated into the cubicle 602, integrated into the workspace 604, and so on. The receiver 640 may be configured to transfer the inbound signal back to the information receiving logic 620 via the transmission lines 625. In another example, the PVLAN system may be broadcast only and thus not include receiver 640.

The system 600 may also include an override panel (not shown) that facilitates establishing wired connections. The override panel may be referred to, for example, as an intelligent service panel connection (ISPC). The ISPC may include, for example, a video port, an RS 232 port, an RS 422 port, an RJ 45 port, an RJ 11 port, an XLR connector, a LAN connector, a BNC connector and the like to facilitate accessing signals like television, telephone, data, and so on. The ISPC is understood to be capable of receiving information signals from the transmission lines 625 and communicating those information signals to an associated electronic device 665 via one or more cables (not shown). By way of illustration, the ISPC may be used in case of driven element 635 failure or receiver 640 failure. In one example the ISPC may be used substantially in parallel with the PVLAN to reduce the amount of electromagnetic radiation present in an office.

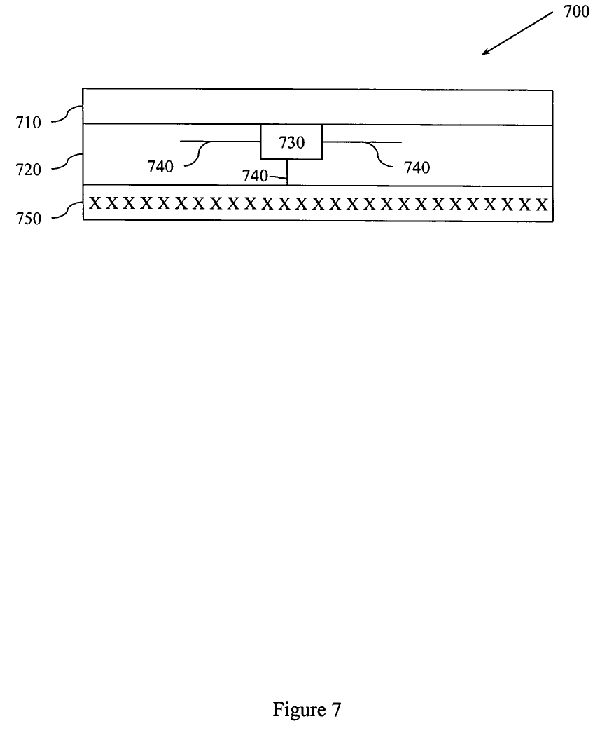

FIG. 7 illustrates a section 700 of a PVLAN-space element into which a PVLAN component has been integrated. A PVLAN-space element can include, for example, a portion of a structure like a cubicle wall, a wall, a floor, a ceiling, a cabinet wall, and so on. A PVLAN-space element can also include, for example, a portion of a piece of furniture like a desktop, a desk, a table top, a table, and so on. The section 700 includes a top layer 710 that may be, for example, a plastic laminate. The section 700 also includes an intermediate layer 720 into which a driven element 730 and radials 740 have been embedded. While three radials are illustrated, it is to be appreciated that a greater and/or lesser number of radials and/or other elements can be employed. The section 700 also includes a bottom layer 750 into which a shield has been embedded. While the section 700 illustrates a three layer laminated construction, it is to be appreciated that other constructions can be employed. For example, the shielding may be provided by a fabric that includes metal fibers configured to act as a shield. Similarly, a first layer may incorporate PVLAN elements like driven element 730, radials 740, transmission lines (not illustrated) and so on. Similarly, the orientation (e.g., top layer, bottom layer) may be different in various applications (e.g., horizontal desktop, vertical cubicle wall).

Thus, example PVLAN systems are described wherein at least one element of the system is integrated into a PVLAN-space element like a portion of a structure or a portion of a piece of furniture. Example structures can include, but are not limited to an office cubicle, an office wall, an office floor, a wall, a floor, a ceiling, a partition, a privacy screen, and so on. Example pieces of furniture can include, but are not limited to, a desk, a work surface, a table associated with an airline seat, an emergency room table, a hospital table, a medical office table, a kiosk surface, a conference room table, a table, a cabinet, and the like. Thus, it is to be appreciated that a PVLAN system can be employed in various structures and/or furniture associated with applications like medical, airline, office, home, hospital, casino, banking, academic, finance, and so on.

While example systems, methods, and so on have been illustrated by describing examples, and while the examples have been described in considerable detail, it is not the applicant's intention to restrict or in any way limit the scope of the appended claims to such detail. It is, of course, not possible to describe every conceivable combination of components or methodologies for purposes of describing the systems, methods, and so on described herein. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicants' general inventive concept. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Gamer, A Dictionary of Modem Legal Usage 624 (2d. Ed. 1995).

1. A system, comprising:
an information receiving logic configured to receive an information signal;
a driven element configured to transmit an outbound information signal at a predetermined power and a predetermined frequency that create a transmission zone that is less than forty eight inches in a plane; and
a transmission line configured to facilitate transferring a first intermediate signal, from which the outbound information signal is derived, from the information receiving logic to the driven element;
where at least one of the information receiving logic, the driven element, and the transmission line are integrated into a PVLAN-space element.

2. The system of claim 1, including a shield configured to mold the transmission zone, where the shield is integrated into a PVLAN-space element.

3. The system of claim 1, including a shield configured to at least partially block electromagnetic radiation from entering the transmission zone, where the shield is integrated into a PVLAN-space element.

4. The system of claim 1, including a shield configured to at least partially block the outbound signal from leaving the transmission zone, where the shield is integrated into a PVLAN-space element.

5. The system of claim 1, the information signal comprising one or more of, a telephone signal, a television signal, a computer signal, a data signal, a facsimile signal, a DSL signal, a broadcast signal, a GPS signal, and a radio signal.

6. The system of claim 5, the telephone signal comprising one or more of, an analog telephone signal, a digital telephone signal, an analog cellular telephone signal, and a digital cellular telephone signal.

7. The system of claim 5, the television signal comprising one or more of, an over the air television signal, a cable television signal, a digital television signal, and a satellite television signal.

8. The system of claim 5, the computer signal comprising one or more of, an IEEE 802.3 signal, an IEEE 802.5 signal, an IEEE 802.11 signal, and an IEEE 802.15.1 signal.

9. The system of claim 5, the radio signal comprising one or more of, an AM signal, an FM signal, an XM signal, and a shortwave signal.

10. The system of claim 1, the PVLAN-space element comprising one or more of, a desktop, a tabletop, a desk, a table, a cubicle wall, a cubicle, an office wall, an office, a wall, and a cabinet.

11. The system of claim 1, the driven element comprising one or more of, an omni directional antenna, a yagi antenna, a horn antenna, a spiral antenna, a helical antenna, a loop antenna, a blade antenna, a flat panel antenna, and a sector antenna.

12. The system of claim 1, the driven element being configured to transmit the outbound information signal in a power range from about 0.01 mW to about 0.1 W.

13. The system of claim 1, the driven element being configured to transmit the outbound information signal in a frequency range from about 500 MHz to about 1.5 GHz.

14. The system of claim 1, where the outbound signal is intended for an electronic device comprising one or more of, a computer, a telephone, a facsimile machine, a monitor, a PDA, a keyboard, a radio, and a GPS.

15. The system of claim 1, comprising a receiver configured to receive an inbound information signal from an electronic device.

16. The system of claim 15, the transmission line being further configured to facilitate transferring a second intermediate signal derived from the inbound information signal from the receiver to the information receiving logic.

17. The system of claim 15, the receiver comprising one or more of, a super heterodyne receiver and a co-axial receiver.

18. The system of claim 1, the transmission line comprising one or more of, a coaxial cable, a low loss cable, a fiber optic cable, a SCSI cable, a LAN cable, an elliptical waveguide cable, a rectangular waveguide cable, a ribbon cable, a CAT 5e cable, a CAT 6 cable, a shielded twisted pair cable, and an unshielded twisted pair cable.

19. The system of claim 2, the shield comprising one or more of, a faraday cage, a copper mesh screen, a welded sheet aluminum plate, a metal textile shield, a plastic film, a wire mesh, a brass plate, a tin plated steel plate, a nickel silver plate, a conductive fabric, and a conductive paint.

20. The system of claim 3, the shield comprising one or more of, a faraday cage, a copper mesh screen, a welded sheet aluminum plate, a metal textile shield, a plastic film, a wire mesh, a brass plate, a tin plated steel plate, a nickel silver plate, a conductive fabric, and a conductive paint.

21. The system of claim 4, the shield comprising one or more of, a faraday cage, a copper mesh screen, a welded sheet aluminum plate, a metal textile shield, a plastic film, a wire mesh, a brass plate, a tin plated steel plate, a nickel silver plate, a conductive fabric, and a conductive paint.

22. The system of claim 2, where the shield is grounded.

23. The system of claim 2, where the shield is bonded to a 0.01 ohm to digital ground connection.

24. The system of claim 3, where the shield is grounded.

25. The system of claim 3, where the shield is bonded to a 0.01 ohm to digital ground connection.

26. The system of claim 4, where the shield is grounded.

27. The system of claim 4, where the shield is bonded to a 0.01 ohm to digital ground connection.

28. The system of claim 1, comprising:
an override panel configured to provide access to one or more wired connections by which the information signal can be received.

29. The system of claim 28 where the override panel includes one or more of, a video port, an RS232 port, an RS 422 port, an RJ45 port, an RJ11 port, an XLR connector, a LAN connector, and a BNC connector.

30. The system of claim 1, where the information receiving logic, the driven element, and the transmission line are integrated into a single PVLAN-space element.

31. The system of claim 1, comprising:
an effective zone indicator configured to visually illustrate a boundary associated with the transmission zone.

32. The system of claim 31, where the effective zone indicator is located on a PVLAN-space element surface.

33. A method, comprising:
receiving an information signal;
selectively deriving an intermediate signal from the information signal;
selectively relaying the intermediate signal to a driven element;
transmitting an outbound information signal derived from the intermediate signal from the driven element at a designated power output and designated frequency, where the combination of designated power and designated frequency produce a limited zone of less than forty eight inches; and
positioning one or more shields to perform one or more of, molding the size of the limited zone, molding the shape of the limited zone, protecting the limited zone from RF interference, and limiting interference produced by transmitting the outbound information signal.

34. The method of claim 33, the information signal comprising one or more of, a telephone signal, a television signal, a computer signal, a facsimile signal, an internet signal, a DSL signal, a broadcast signal, a GPS signal, and a radio signal.

35. The method of claim 33, where the outbound information signal is transmitted with a power of about 0.01 mW to about 1 mW.

36. The method of claim 35, where the outbound information signal is transmitted with a frequency of about 500 MHz to about 1.5 GHz.

37. A piece of furniture, comprising:
an information receiving logic configured to receive an information signal;
a driven element configured to transmit an outbound information signal at a predetermined power and a predetermined frequency that create a transmission zone that is less than forty eight inches in a plane;
a transmission line configured to facilitate transferring a first intermediate signal, from which the outbound information signal is derived, from the information receiving logic to the driven element;
a shield configured to perform one or more of, molding the transmission zone, to at least partially block electromagnetic radiation from entering the transmission zone, and to at least partially block the outbound signal from leaving the transmission zone; and
an override panel configured to provide access to a wired connection by which the information signal can be received;
where the information receiving logic, the driven element, the transmission line, the override panel, and the shield are integrated into the piece of furniture.

38. A method of altering a piece of furniture, comprising:
providing a shielding material configured to affect the transmission of electromagnetic radiation; and
integrating the shielding material into the piece of furniture.

39. The method of claim 38, comprising:
providing a driven element configured to transmit a PVLAN signal by electromagnetic radiation; and
integrating the driven element into the piece of furniture.
